(19) United States
(12) Patent Application Publication
(10) Pub. No.: US 2024/0411047 A1
(43) Pub. Date: Dec. 12, 2024

(54) METHOD FOR EVALUATING STABILITY OF TUNNEL SURROUNDING ROCK CONSIDERING CREEP CHARACTERISTICS OF STRUCTURAL PLANE

(71) Applicants: China University of Geosciences (Wuhan), Wuhan (CN); Institute of Rock and Soil Mechanics, Chinese Academy of Sciences, Wuhan (CN)

(72) Inventors: Guohua ZHANG, Wuhan (CN); Feng XIONG, Wuhan (CN); Zhicheng TANG, Wuhan (CN); Dongjie HUA, Wuhan (CN); Zongwu CHEN, Wuhan (CN); Junpeng ZOU, Wuhan (CN); Jinchao WANG, Wuhan (CN)

(21) Appl. No.: 18/609,468

(22) Filed: Mar. 19, 2024

(30) Foreign Application Priority Data
Jun. 6, 2023 (CN) 202310659685.X

(51) Int. Cl. G01V 20/00; E21D 9/00; G06F 30/20

(52) U.S. Cl. CPC G01V 20/00; E21D 9/003; G06F 30/20

(57) ABSTRACT

The application provides a method for evaluating stability of a tunnel surrounding rock considering creep characteristics of a structural plane, which includes the following steps: S1, discretizing a tunnel surrounding rock region, and constructing a numerical model of a tunnel-surrounding rock structure; S2, initializing the numerical model; S3, presetting a creep time, and obtaining a normal force of a structural plane node based on an initialized numerical model; S4, based on the normal force, obtaining an unbalanced force of a rock mass region element; and S5, judging the unbalanced force of the rock mass region element, and completing a stability evaluation of the tunnel surrounding rock.

### CROSS-REFERENCE TO RELATED APPLICATIONS

This application claims priority to Chinese Patent Application No. 202310659685.X, filed on Jun. 6, 2023, the contents of which are hereby incorporated by reference.

### TECHNICAL FIELD

The application belongs to the technical field of tunnel surrounding rock stability evaluation, and in particular to a method for evaluating stability of a tunnel surrounding rock considering creep characteristics of a structural plane.

### BACKGROUND

Under the action of high stress, due to the creep characteristics of rock mass itself, the surrounding rock of mountain tunnel may be deformed greatly during the operation period, resulting in tunnel damage. Rock mass is composed of rock and structural plane, and the creep of structural plane will significantly affect the deformation and failure of rock mass, especially in fractured rock strata. Therefore, it is particularly important to study the creep of structural plane.

At present, a lot of research focuses on the creep characteristics of rocks, and the results are also rich. As early as 1939, Griggs (Griggs D. Creep of Rocks. J Geol [m]. 1939: 225-251) had done a lot of creep tests on sandstone, limestone, shale specimen and mica, and put forward the corresponding creep constitutive model. Later, scholars at home and abroad continuously enriched the rock creep model. The creep constitutive model of rock is written in finite element or finite difference format, which is convenient for numerical evaluation of rock engineering such as tunnel. For example, the existing commercial software, ANSYS, ABAQUS, FLAC3D and other software all have rock creep calculation modules. There are more and more researches on creep constitutive model of structural plane in recent years, but the realization of corresponding numerical simulation is still blank. For example,

Chinese patent CN 113919148A discloses a method for establishing a nonlinear creep model of rock, which includes the following steps: carrying out indoor uniaxial compression test of rock to obtain the average compressive strength of rock; carrying out indoor rock creep test by graded loading; drawing the complete strain-time curve of rock obtained from indoor rock creep test and classifying the graded strain-time curve of rock under different stress levels; identifying the component types of creep model and constructing the initial creep model; fitting the nonlinear relationship between creep rate and corresponding creep time history in accelerated creep stage of rock; finally, obtaining the constitutive equation and creep equation of rock nonlinear creep model. However, this method fails to realize the numerical simulation of rock creep.

Chinese patent CN 110274835A discloses a method for improving the shear creep model of Burgers rock, which includes the following steps: S1, aiming at the time difference of the shear strength of rock in the creep state, constructing a nonlinear element composed of a plastic element and a viscous element in parallel to describe the mechanical characteristics of rock in the accelerated creep stage; S2, describing the aging damage function D(t) in the accelerated creep stage of rocks by using Kachanov's law, which is widely used in the rheological field; S3, based on the aging damage function D(t), determining the specific expression τ_{d}(t) of the shear strength τ_{d}; S4, introducing the residual strength τᵣ into the shear strength function τd(t), and constructing a modified shear strength function τ_{d}(t) considering the residual strength; S5, substituting the modified shear strength function τ_{d}(t) into the nonlinear element in step S1 to determine the element constitutive equation γ(t); S6, introducing the element constitutive equation γ(t) into the classical Burgers model constitutive equation, and obtaining the improved Burgers model constitutive equation γ_{B}(t) which accurately reflects the mechanical behavior of the whole creep process. This method also failed to realize the numerical simulation of rock creep.

Chinese patent CN 114547746A discloses a discrete element method and system for simulating creep instability of roadway surrounding rock, which includes inversion of compression fracturing model according to stress-strain curve to obtain reasonable contact surface and reasonable block parameter values; according to the rock creep curve, the first uniaxial creep numerical model established according to the parameter value is inverted to obtain the reasonable block creep parameter value; according to the rock creep curve, the second uniaxial creep numerical model constructed according to the reasonable contact surface and the reasonable block creep parameter values is inverted to obtain the reasonable block creep parameter degradation equation; performing a grid division on the simulation model based on the degradation equation of reasonable block creep parameters; the divided simulation model is simulated to obtain the cumulative tensile crack length and cumulative shear crack length of each grid; based on the cumulative tensile crack length and cumulative shear crack length, determining the range of creep instability of surrounding rock of roadway to be simulated. However, this method may not accurately analyze the stress-deformation situation of roadway or tunnel, and has certain limitations.

### SUMMARY

In order to solve the above technical problems, the application provides a method for evaluating stability of a tunnel surrounding rock considering creep characteristics of a structural plane. Based on the Nishihara creep model, the finite difference method is adopted to realize the creep stress-deformation simulation of tunnel surrounding rock with structural planes, and the stability of tunnel surrounding rock is analyzed by observing the deformation value. This method may simulate and evaluate the long-term deformation characteristics of rock tunnels and other projects, and provides an important idea for engineering stability evaluation.

In order to achieve the above objectives, the application provides a method for evaluating stability of a tunnel surrounding rock considering creep characteristics of a structural plane, which includes the following steps:
S1, discretizing a tunnel surrounding rock region, and constructing a numerical model of a tunnel-surrounding rock structure;
S2, initializing the numerical model;
S3, presetting a creep time, and obtaining a normal force of a structural plane node based on an initialized numerical model;
S4, based on the normal force, obtaining an unbalanced force of a rock mass region element; and
S5, judging the unbalanced force of the rock mass region element, and completing a stability evaluation of the tunnel surrounding rock.

Optionally, discretizing the tunnel surrounding rock region includes:
using a quadrilateral element to discretize a rock mass region, using a one-dimensional line element to discretize the structural plane, and nodes of a structural plane element are shared with nodes of a rock mass element.

Optionally, initializing the numerical model includes:
setting parameters and boundary conditions, and initializing a displacement field and a stress field of the numerical model; where, the parameters include: an elastic modulus of the structural plane, a viscosity coefficient, a plastic limit, an elastic modulus of a rock mass and Poisson's ratio; the boundary conditions include a displacement boundary and a mechanical boundary; the displacement field includes a displacement on the structural plane and a displacement of the rock mass; the stress field includes a stress on the structural plane and a stress of the rock mass.

Optionally, obtaining the unbalanced force of the rock mass region element includes:
based on the normal force, obtaining a tangential force of the structural plane node;
based on the normal force and the tangential force, obtaining a nodal force of rock mass element node;
based on the nodal force, obtaining the unbalanced force of the rock mass region element.

The method for evaluating the stability of the tunnel surrounding rock considering the creep characteristics of the structural plane, where the normal force is:

$${F}_{n} = - {k}_{n} \times {u}_{n}$$

where Fₙ is the normal force, kₙ is a normal stiffness, and uₙ is a normal displacement.

Optionally, obtaining the tangential force of the structural plane node includes:
judging whether the normal force exceeds a maximum plastic stress, if the normal force exceeds the maximum plastic stress, calculating the tangential force according to a first preset equation, and if the normal force doesn't exceed the maximum plastic stress, calculating the tangential force according to a second preset equation;

the first preset equation is:

$${F}^{′} = \frac{1}{X} [ {u}^{′} - {u}^{0} + {YF}^{0} - ( \frac{1 - \frac{{k}_{2} Δ t}{2 η}}{1 + \frac{{k}_{2} Δ t}{2 η}} - 1 ) {u}_{2}^{0} ]$$

where F′ is the tangential force, and X and Y are calculated according to following formulas:

$$X = \frac{1}{{k}_{1}} + \frac{Δ t}{2 ( 1 + \frac{{k}_{2} Δ t}{2 η} ) η} \\ Y = \frac{1}{{k}_{1}} - \frac{Δ t}{2 ( 1 + \frac{{k}_{2} Δ t}{2 η} ) η}$$

u′ is a creep displacement, u⁰ is an initial displacement, F⁰ is an initial shear force, k is an elastic modulus of a spring element, Δt is a creep time and η is a creep deformation rate;

the second preset equation is:

$${F}^{′} = \frac{1}{{X}^{′}} [ {u}^{′} - {u}^{0} + {Y}^{′} {F}^{0} - ( \frac{1 - \frac{{k}_{2} Δ t}{2 η}}{1 + \frac{{k}_{2} Δ t}{2 η}} - 1 ) {u}_{2}^{0} + \frac{{F}_{s} Δ t}{{η}_{3}} ]$$

where X′ and Y′ are calculated according to following formulas:

$${X}^{′} = \frac{1}{{k}_{1}} + \frac{Δ t}{2 ( 1 + \frac{{k}_{2} Δ t}{2 η} ) η} + \frac{Δ t}{2 {η}_{3}} \\ {Y}^{′} = \frac{1}{{k}_{1}} - \frac{Δ t}{2 ( 1 + \frac{{k}_{2} Δ t}{2 η} ) η} - \frac{Δ t}{2 {η}_{3}} ,$$

Fₛ is a force on a plastic element.

Optionally, obtaining the nodal force of the rock mass element node includes: adding the normal force and tangential force of the structural plane node to a corresponding rock mass element node in the numerical model to obtain a new nodal force.

Optionally, obtaining the unbalanced force of the rock mass region element includes:
base on the nodal force, obtaining a nodal velocity of the rock mass region;
based on a nodal velocity, obtaining a strain increment of the rock mass region node;
based on the strain increment, obtaining the stress increment and a total stress of rock mass region node;
based on the total stress, obtaining the unbalanced force of the rock mass region element.

Optionally, the nodal velocity of the rock mass region is:

$${u}_{i}^{l} ( t + \frac{Δ t}{2} ) = {u}_{i}^{l} ( t - \frac{Δ t}{2} ) + \frac{{F}_{i}^{l} ( t ) + {f}_{i}^{l} ( t )}{{m}^{l} \cdot Δ t}$$

where uᵢ^{l} is the velocity of l node in i direction at a time step t, Fᵢ^{l}(t) is an unbalanced force component of the l node in i direction at the time step t, and m^{l} is a concentrated mass of the l node;

the strain increment of the rock mass region node is:

$$Δ {ε}_{ij} = \frac{1}{2} ( {u}_{i , j} + {u}_{j , i} ) Δ t$$

where Δεᵢⱼ is the strain increment, u_{i,j} is a partial derivative of a displacement uᵢ in xⱼ direction, and u_{j,i} is a partial derivative of displacement uⱼ in xᵢ direction;

the stress increment of the rock mass region node is:

$$Δ {σ}_{ij} = 2 G {ε}_{ij} + \frac{E}{( 1 + μ ) ( 1 - 2 μ )} {ε}_{k k} {δ}_{ij}$$

where Δσᵢⱼ is the stress increment, G is a shear elastic modulus, εᵢⱼ is a strain of an element ij, E is the elastic modulus, Eₖₖ is an average stress on an element, and δᵢⱼ is a Kronecker symbol;

the total stress of rock mass region node is:

$${σ}_{ij} = {\sum }_{t} Δ {σ}_{ij}$$

where σᵢⱼ is the total stress;

the unbalanced force of the rock mass region element is:

$${F}^{l} = \frac{1}{2} {σ}_{ij} ( {n}^{( 1 )} {S}^{( 1 )} + {n}^{( 2 )} {S}^{( 2 )} )$$

where F^{l} is the unbalanced force of the rock mass region element, n⁽¹⁾ is a normal vector of elementary volume side 1, S⁽¹⁾ is an area of the elementary volume side 1, n⁽²⁾ is a normal vector of elementary volume side 2, and S⁽²⁾ is an area of the elementary volume side 2.

Optionally, judging the unbalanced force of the rock mass region element includes:
judging whether the unbalance force of the rock mass region element is greater than a preset allowable tolerance, if so, reducing a preset creep time, returning to the S3, and re-calculating, otherwise, performing a calculation of a next time step;
judging whether the next time step is greater than the preset creep time, and if not, returning to the S3 for a next round of calculation; if so, ending the calculation to obtain a deformation and a stress of the rock mass and the structural plane;
based on the calculated deformation and stress of the rock mass and the structural plane, obtaining a maximum deformation value of tunnel surrounding rock region; and
judging whether the maximum deformation value is less than a preset allowable value, if less than the allowable value, a tunnel is stable, otherwise, the tunnel is unstable.

Compared with the prior art, the application has the following advantages and technical effects.

Firstly, long-term deformation simulation and stability evaluation of engineering excavation such as tunnels and slopes in complex crack rock masses may be realized; secondly, the grid division is simple and fast, which avoids the high requirement of finite element calculation on the grid; and thirdly, the calculation principle is simple, the programming is easy and the calculation velocity is fast.

### BRIEF DESCRIPTION OF THE DRAWINGS

The accompanying drawings, which constitute a part of this application, are used to provide a further understanding of this application. The illustrative embodiments of this application and the descriptions are used to explain this application, and do not constitute an improper limitation of this application. In the attached drawings:

FIG. 1 is a schematic diagram for calculating unbalanced force of rock mass according to an embodiment of the present application.

FIG. 2 is a schematic diagram of the division of rock mass regions and structural plane elements according to the embodiment of the present application.

FIG. 3A is a whole schematic flow chart of finite difference solution for creep of tunnel surrounding rock structural plane according to the embodiment of the present application.

FIG. 3B is a schematic flow chart of structural plane Nishihara model calculation according to the embodiment of the present application.

FIG. 3C is a schematic flow chart of elastic simulation of rock mass region according to the embodiment of the present application.

FIG. 4A is a schematic diagram of a tunnel geometric model according to an embodiment of the present application.

FIG. 4B is gridded tunnel geometric model according to an embodiment of the present application.

FIG. 5 is a comparative schematic diagram of numerical simulation and monitoring according to an embodiment of the present application

FIG. 6 is a schematic diagram of a five-element viscoelastic-plastic mechanical model according to an embodiment of the present application.

### DETAILED DESCRIPTION OF THE EMBODIMENTS

It should be noted that the embodiments in this application and the features in the embodiments may be combined with each other without conflict. The present application will be described in detail with reference to the attached drawings and embodiments.

It should be noted that the steps shown in the flowchart of the accompanying drawings may be executed in a computer system such as a set of computer-executable instructions, and although the logical order is shown in the flowchart, in some cases, the steps shown or described may be executed in a different order from here.

Before introducing the specific steps of this embodiment, firstly the basic hypothesis and Nishihara structural model of this embodiment are introduced.

### Basic Hypothesis

(1) Stress-strain relation of rock mass satisfies elastic constitutive relation;
(2) Stress-strain relation of structural plane satisfies Nishihara creep relation;
(3) The deformation of rock mass and structural plane satisfies the assumption of small deformation.

### Nishihara Structural Model

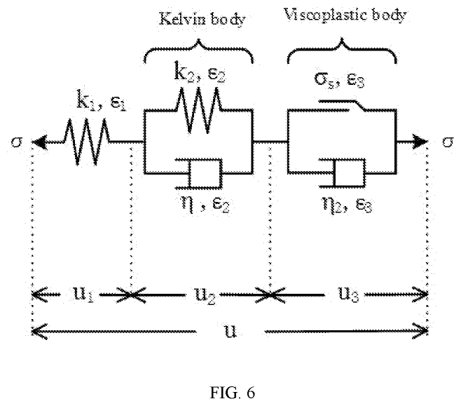

Nishihara model may comprehensively reflect the elastic-viscoelastic-viscoplasticity creep deformation characteristics of the structural plane. Nishihara model is composed of a spring, a Kelvin body and a viscoplastic body in series, and the mechanical model is shown in FIG. 6, in which u represents the displacement, k₁ and k₂ respectively represent elastic modulus of the spring, η and η₂ respectively represent the Newtonian viscosity coefficient of damper in Kelvin body and viscoplastic body, σ₁ and σ₂ respectively represent the stress of a single spring and Kelvin body, σₛ represents the yield limit of the plastic element, ε₁, ε₂ and ε₃ respectively represent the strain of a single spring, Kelvin body and viscoplastic body. The constitutive equation is divided into two cases:

when σ₀<σₛ, the model degenerates into a generalized Kelvin model:

$$ε = \frac{{σ}_{0}}{{k}_{1}} + \frac{{σ}_{0}}{{k}_{2}} ( 1 - {e}^{- \frac{{k}_{2}}{{η}_{1}} t} ) ; \qquad ( 1 )$$

when σ₀≥σₛ,

$$ε = \frac{{σ}_{0}}{{k}_{1}} + \frac{{σ}_{0}}{{k}_{2}} ( 1 - {e}^{- \frac{{k}_{2}}{{η}_{1}} t} ) + \frac{{σ}_{0} + {σ}_{s}}{{η}_{2}} t \qquad ( 2 )$$

It can be seen that the values of k₁ and k₂ jointly affect the final creep deformation, and the value of k₁ directly affects the instantaneous deformation. η determines the slope of the creep curve, that is, the rate of creep deformation, and σₛ determines whether the structural plane enters plasticity.

### Derivation of Finite Difference Scheme for Nishihara Structural Plane Model

The normal force of the structural plane is calculated according to elasticity, namely:

$${F}_{n} = - {k}_{n} \times {u}_{n} \qquad ( 3 )$$

The tangential force of the structural plane is calculated according to Nishihara model, and the displacement increment is the sum of displacement increments of spring body, Kelvin body and viscoplastic body. For the spring body:

$${u}_{1}^{′} = {u}_{I}^{0} + \frac{{F}^{′} + {F}^{0}}{{k}_{1}} , \qquad ( 4 )$$

where, u₁⁰ and u₁′ respectively represent the initial displacement of the spring body and the displacement after the time step Δt, and F₀ and F′ respectively represent the initial shear force and the shear force after the time step Δt.

For Kelvin body, it can be obtained that:

$${u}_{2}^{′} = \frac{1}{1 + \frac{{k}_{2} Δ t}{2 η}} [ ( 1 - \frac{{k}_{2} Δ t}{2 η} ) {u}_{2}^{0} + ( {F}^{′} + {F}^{0} ) \frac{Δ t}{2 η} ] , \qquad ( 5 )$$

where u₂⁰ and u₂′ respectively represent the initial displacement of Kelvin body and the displacement after time step Δt.

For viscoplastic body, it can be obtained that:

$${u}_{3}^{′} - {u}_{3}^{0} = ( {F}^{0} + {F}^{′} - 2 {F}_{S} ) \frac{Δ t}{2 {η}_{3}} , \qquad ( 6 )$$

where u₃⁰ and u₃′ respectively represent the initial displacement of the viscoplastic body and the displacement after the time step Δt. F_{S} represents the forces acting on the plastic element respectively.

When the structural plane does not enter plasticity, that is, σ₀<σₛ, u′−u⁰=u₁′−u₁⁰+u₂′−u₂⁰, combined with formulas (4) and (5), Nishihara model degenerates into generalized Kelvin model, and the expression of shear force is:

$${F}^{′} = \frac{1}{X} [ {u}^{′} - {u}^{0} + {YF}^{0} - ( \frac{1 - \frac{{k}_{2} Δ t}{2 η}}{1 + \frac{{k}_{2} Δ t}{2 η}} - 1 ) {u}_{2}^{0} ] , \qquad ( 7 )$$

where

$$X = \frac{1}{{k}_{1}} + \frac{Δ t}{2 ( 1 + \frac{{k}_{2} Δ t}{2 η} ) η} \qquad ( 8 )$$

$$Y = \frac{1}{{k}_{1}} - \frac{Δ t}{2 ( 1 + \frac{{k}_{2} Δ t}{2 η} ) η} . \qquad ( 9 )$$

When the structural plane enters plasticity, that is, σ₀≥σₛ, u′−u⁰=u₁′−u₁⁰+u₂′−u₂⁰+u₃′−u₃⁰, combined with formulas (4), (5) and (6), the expression of shear force in Nishihara model may be obtained:

$${F}^{′} = \frac{1}{{X}^{′}} [ {u}^{′} - {u}^{0} + {Y}^{′} {F}^{0} - ( \frac{1 - \frac{{k}_{2} Δ t}{2 η}}{1 + \frac{{k}_{2} Δ t}{2 η}} - 1 ) {u}_{2}^{0} + \frac{{F}_{S} Δ t}{{η}_{3}} ] , \qquad ( 10 )$$

where

$${X}^{′} = \frac{1}{{k}_{1}} + \frac{Δ t}{2 ( 1 + \frac{{k}_{2} Δ t}{2 η} ) η} + \frac{Δ t}{2 {η}_{3}} \qquad ( 11 )$$

$${Y}^{′} = \frac{1}{{k}_{1}} - \frac{Δ t}{2 ( 1 + \frac{{k}_{2} Δ t}{2 η} ) η} - \frac{Δ t}{2 {η}_{3}} . \qquad ( 12 )$$

### Derivation of Finite Difference Scheme for Rock Mass Deformation

The rock mass region is discretized into the quadrilateral element, and the node is taken as the calculation object, and the force and mass are concentrated on the node, which is solved by the motion equation in time domain. The equation of motion of that node may be expressed as follow,

$$\frac{\partial {u}_{i}^{l}}{\partial t} = \frac{{F}_{i}^{l} ( t ) + {f}_{i}^{l} ( t )}{{m}^{l}} \qquad ( 13 )$$

where uᵢ^{l} is the velocity of the l node in the i direction at time step t, Fᵢ^{l}(t) is the unbalanced force component of the l node in the i direction at time step t, and m^{l} is the concentrated mass of the l node. In the analysis, virtual mass is used to ensure the numerical stability. Approximating by central difference, obtaining:

$${u}_{i}^{l} ( t + \frac{Δ t}{2} ) = {u}_{i}^{l} ( t - \frac{Δ t}{2} ) + \frac{{F}_{i}^{l} ( t ) + {f}_{i}^{l} ( t )}{{m}^{l} \cdot Δ t} , \qquad ( 14 )$$

where fᵢ^{l}(t) is non-viscous damping, which attenuates the vibration of the system to a balanced state when solving static problems, which is expressed as,

$${f}_{i}^{l} ( t ) = - α \vert {F}_{i}^{l} ( t ) \vert sign ( {u}_{i}^{l} ) , \qquad ( 15 )$$

where α is the damping coefficient and the default value is 0.8.

The rate is used to calculate the element strain increment at a certain time step,

$$Δ {ε}_{ij} = \frac{1}{2} ( {u}_{i , j} + {u}_{j , i} ) Δ t . \qquad ( 16 )$$

The stress increment Δσᵢⱼ is obtained from the elastic constitutive equation,

$$Δ {σ}_{ij} = 2 G {ε}_{ij} + \frac{E}{( 1 + μ ) ( 1 - 2 μ )} {ε}_{k k} {δ}_{ij} . \qquad ( 17 )$$

The stress increment of each time step is superimposed to obtain the total stress of the latest time step:

$${σ}_{ij} = {\sum }_{t} Δ {σ}_{ij} . \qquad ( 18 )$$

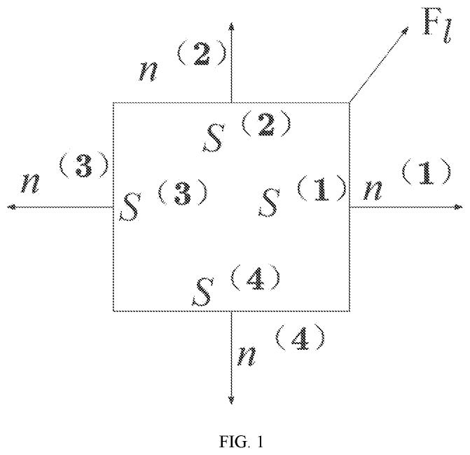

Using the stress of each element, the unbalanced force Fᵢ^{l}(t) of each node is calculated, as shown in FIG. 1:

$${F}^{l} = \frac{1}{2} {σ}_{ij} ( {n}^{( 1 )} {S}^{( 1 )} + {n}^{( 2 )} {S}^{( 2 )} ) , \qquad ( 19 )$$

where n is the normal vector of element side, S is the area or length of element side, n⁽¹⁾ is the normal vector of elementary volume side 1, S⁽¹⁾ is the area of elementary volume side 1, for quadrilateral element, it refers to the length of side 2, n⁽²⁾ is the normal vector of elementary volume side 2, and S⁽²⁾ is the area of elementary volume side 2. If the unbalanced force of all nodes is less than the tolerance, the iteration ends.

### Coupling Solution of Stress and Deformation of Rock Mass and Structural Plane

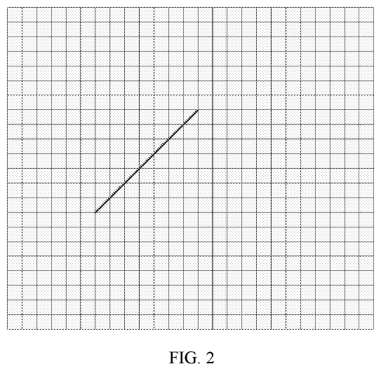

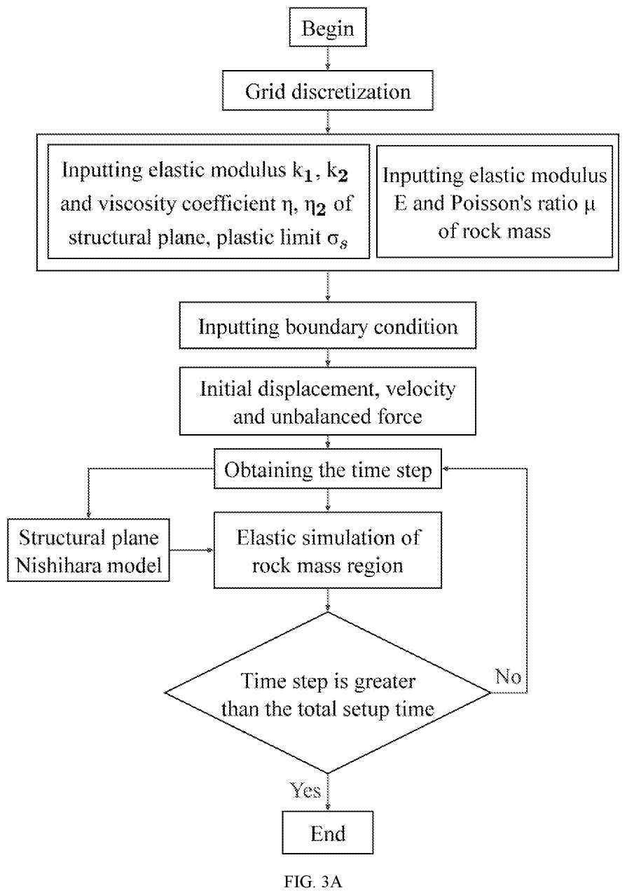

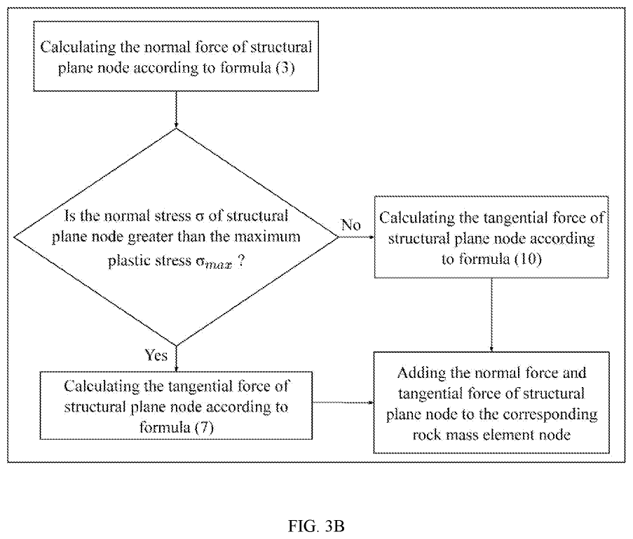

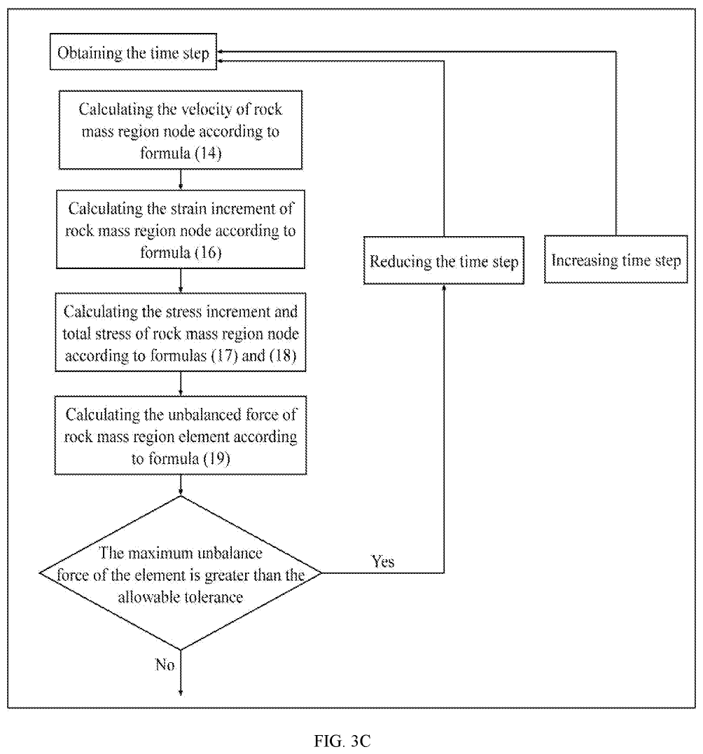

The rock mass region is discretized into quadrilateral element, and the structural plane is discretized into one-dimensional line element. The structural plane element and the rock mass region element share nodes, as shown in FIG. 2. In the calculation, it is necessary to add the unbalanced force on the structural plane to the corresponding rock mass nodes to complete the iterative solution. The whole solution process is shown in FIG. 3.

As shown in FIG. 3, the embodiment of the present application provides a method for evaluating stability of a tunnel surrounding rock considering creep characteristics of a structural plane, and the implementation method includes the following steps:
S1, discretizing the simulation research area. The quadrilateral element is used to discretize the rock mass region, the one-dimensional line element is used to discretize the structural plane, and the nodes of the structural plane element are shared with the nodes of the rock mass element.
S2, inputting parameters: inputting elastic modulus k₁ and k₂ of the structural plane, viscosity coefficients η and η2, plastic limit σₛ, elastic modulus E of rock mass and Poisson's ratio μ;
S3, inputting boundary conditions of the model, including displacement boundary and mechanical boundary;
S4, initializing the displacement field and stress field of the model, including displacement and stress on the structural plane, and displacement, velocity and stress of rock mass;
S5, acquiring the time step, and calculating the normal force or normal stress of the structural plane node according to formula (3);
S6, judging whether the normal stress a exceeds the maximum plastic stress σmax; if the normal stress σ exceeds the maximum plastic stress σmax, the tangential force of structural plane node is calculated according to formula (7); if the normal stress σ does not exceed the maximum plastic stress σmax, the tangential force of structural plane node is calculated according to formula (10);
S7, adding the normal force and tangential force of structural plane node to the corresponding rock mass element nodes to obtain a new nodal force (unbalanced force);
S8, calculating the velocity of rock mass region node according to formula (14);
S9, calculating the strain increment of rock mass region node according to formula (16);
S10, calculating the stress increment and total stress of rock mass region node according to formulas (17) and (18);
S11, calculating the unbalanced force of rock mass region element according to formula (19);
S12, judging whether the maximum unbalance force of the element is greater than the allowable tolerance, if the maximum unbalance force of the element is greater than the allowable tolerance, reducing the time step, return to S5, and recalculating; if the maximum unbalance force of the element is not greater than the allowable tolerance, proceeding to the calculation of the next time step;
S13, judging whether the next time step is greater than the set time, and if the next time step is not greater than the set time, returning to S5 for the next round of calculation; If the next time step is greater than the set time, the calculation is finished; and
S14, observing whether the maximum deformation value of tunnel surrounding rock region is less than the allowable value required by the specification. If the maximum deformation value is less than the allowable value, it indicates that the tunnel is stable in a given operation time; if the maximum deformation value is greater than this value, it indicates that the tunnel is unstable.

### A Specific Implementation Case:

### (1) Creep Calculation of a Tunnel

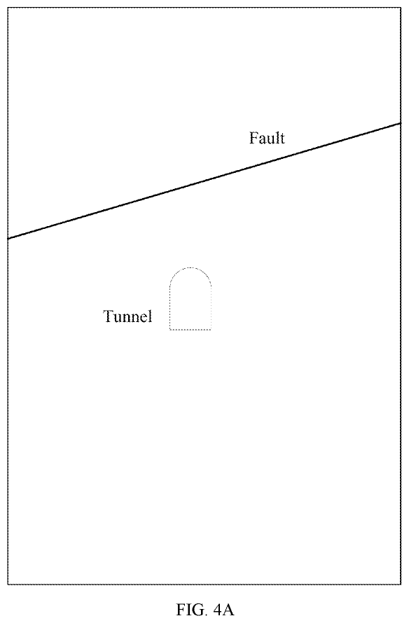

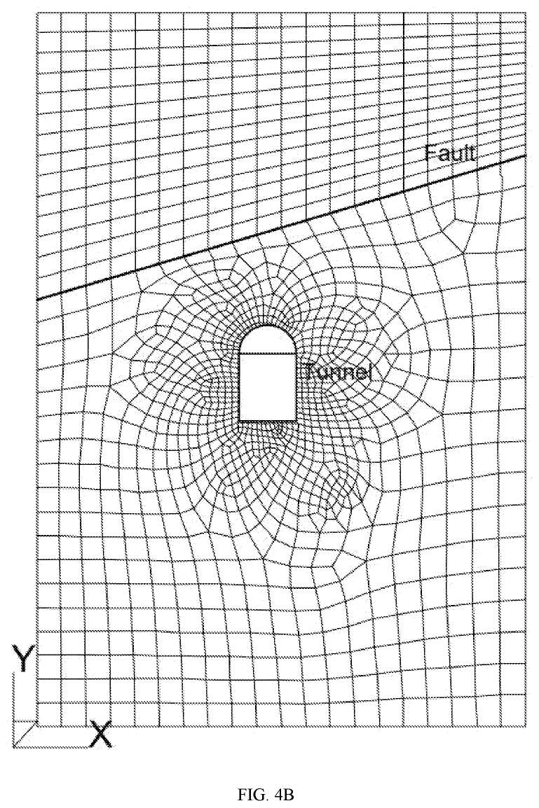

Engineering background: a tunnel is a ridge-crossing tunnel, which is located between Yuyangxi Village and Liu village in Honghuatao, Yidu City. The entrance end is located in Yuyangxi Village, and the exit end is located in Liu village. The maximum buried depth is about 238 meters, and the horizontal length is 1011.2 meters. The tunnel belongs to a medium-long tunnel. There is a fault F1 above the tunnel, which extends over 1 kilometer on the surface, as shown in FIG. 4A and FIG. 4B. The possibility of tunnel instability is high.

### Implementation Method:

(1) Establishing a numerical model. According to the introduction of engineering background, the tunnel geometry structure is simplified and the tunnel-surrounding rock structure model is established, as shown in FIG. 4A. The length of the left and right boundaries of the model is approximately 30 times of span, the upper boundary is taken from the surface, and the lower boundary is taken from the center of the tunnel down to 25 times of the tunnel height. The overall size of the final model is 100 m×338 m×1 m (width×height×thickness). The quadrilateral element is used to discretize the rock mass region, the one-dimensional line element is used to discretize the fault, and the nodes of the structural plane element are shared with the nodes of the rock mass element. There are 8,620 quadrilateral elements with 32,624 nodes, including 32 fault elements, as shown in FIG. 4B.
(2) Inputting parameters: inputting elastic modulus k₁, k₂ and viscosity coefficient η, η₂ of structural plane, plastic limit σₛ, elastic modulus E and Poisson's ratio μ of rock mass;
(3) Inputting the boundary conditions of the model, including displacement boundary and mechanical boundary;
(4) Applying self-weight and structural stress to simulate stress field, including displacement and stress on structural plane and displacement, velocity and stress of rock mass;

$${σ}_{Z} = γ H {σ}_{H} = λ {σ}_{Z} , \qquad ( 20 )$$

where λ=0.3. σ_{z} and σ_{H} are gravity stress and tectonic stress respectively, and H is buried depth.
(5) Obtaining the creep time of 0.1 year, and calculating the normal force or normal stress of structural plane nodes according to formula (3);
(6) Judging whether the normal stress σ exceeds the maximum plastic stress σₘₐₓ. If the normal stress σ exceeds the maximum plastic stress σₘₐₓ, calculating the tangential force of structural plane nodes according to formula (7); if the normal stress σ does not exceed the maximum plastic stress σₘₐₓ, calculating the tangential force of structural plane node according to formula (10);
(7) Adding the normal force and tangential force of the structural plane node to the corresponding rock mass element nodes to obtain a new nodal force (unbalanced force);
(8) Calculating the velocity of rock mass region node according to formula (14);
(9) Calculating the strain increment of rock mass region node according to formula (16);
(10) Calculating the stress increment and total stress of rock mass region node according to formulas (17) and (18);
(11) Calculating the unbalanced force of rock mass region element according to formula (19);
(12) Judging whether the maximum unbalance force of the element is greater than the allowable tolerance, if the maximum unbalance force of the element is greater than the allowable tolerance, reducing the time step, returning to (5), and recalculating; if the maximum unbalance force of the element is not greater than the allowable tolerance, performing the calculation of the next time step.
(13) Judging whether the next time step is greater than the set time, and if the next time step is not greater than the set time, returning to (5) for the next round of calculation; If the next time step is greater than the set time, ending the calculation; the deformation and stress of rock mass and structural plane are obtained.

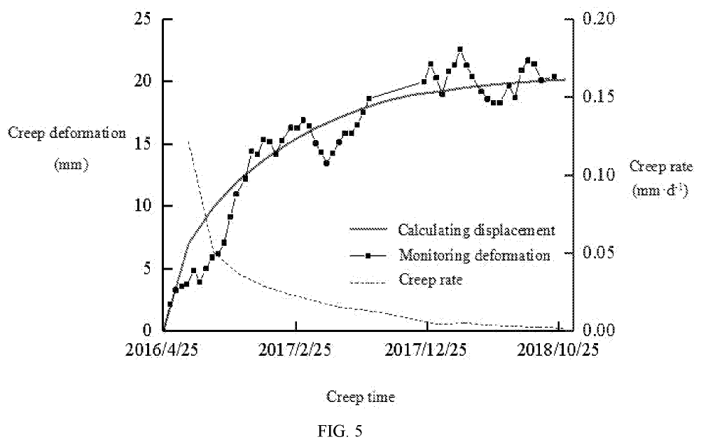

This calculation may obtain the deformation of all nodes of surrounding rock, and find out the maximum deformation of nodes as the maximum deformation value.
(14) Observing whether the maximum deformation value of tunnel surrounding rock region is less than the allowable value required by the specification. If the maximum deformation value is less than the allowable value, it indicates that the tunnel is stable in a given running time; if the maximum deformation value is greater than the allowable value, it indicates that the tunnel is unstable.
(15) Re-inputting the creep time as 0.2, 0.3, 0.4, 0.5, 0.6, 0.7, 0.8, 0.9, 1, 2 and 3 years respectively, and repeating (5) to (15) to calculate the deformation of tunnel surrounding rock.
(16) Selecting the vertex of the hole as the monitoring point to obtain the vertical displacement change after excavation, and compare the calculation result of this method with the monitoring data. FIG. 5 shows the comparison between numerical calculation and monitoring results. It can be seen that in the monitoring date, the simulation results are very close to the measured deformation in numerical value, and the trend is consistent with the actual displacement process line of the measuring point. The initial deformation is faster, and the deformation rate tends to 0 mm/d with the increase of time, which has a stable trend. The above is only the preferred embodiment of this application, but the protection scope of this application is not limited to this. Any change or replacement that may be easily thought of by a person familiar with this technical field within the technical scope disclosed in this application should be included in the protection scope of this application. Therefore, the protection scope of this application should be based on the protection scope of the claims.

What is claimed is:

1. A method for evaluating stability of a tunnel surrounding rock considering creep characteristics of a structural plane, comprising:
S1, discretizing a tunnel surrounding rock region, and constructing a numerical model of a tunnel-surrounding rock structure;
S2, initializing the numerical model;
S3, presetting a creep time, and obtaining a normal force of a structural plane node based on an initialized numerical model;
S4, based on the normal force, obtaining an unbalanced force of a rock mass region element;
wherein obtaining the unbalanced force of the rock mass region element comprises:
based on the normal force, obtaining a tangential force of the structural plane node;
based on the normal force and the tangential force, obtaining a nodal force of a rock mass element node; and
based on the nodal force, obtaining the unbalanced force of the rock mass region element;
wherein obtaining the tangential force of the structural plane node comprises:
judging whether the normal force exceeds a maximum plastic stress, if so, calculating the tangential force according to a first preset equation, otherwise, calculating the tangential force according to a second preset equation;
the first preset equation is:
$${F}^{′} = \frac{1}{X} [ {u}^{′} - {u}^{0} + {YF}^{0} - ( \frac{1 - \frac{{k}_{2} Δ t}{2 η}}{1 + \frac{{k}_{2} Δ t}{2 η}} - 1 ) {u}_{2}^{0} ]$$
wherein F′ is the tangential force, and X and Y are calculated according to following formulas:
$$X = \frac{1}{{k}_{1}} + \frac{Δ t}{2 ( 1 + \frac{{k}_{2} Δ t}{2 η} ) η} \\ Y = \frac{1}{{k}_{1}} - \frac{Δ t}{2 ( 1 + \frac{{k}_{2} Δ t}{2 η} ) η}$$
u′ is a creep displacement, u⁰ is an initial displacement, F⁰ is an initial shear force, k is an elastic modulus of a spring element, Δt is the creep time and η is a creep deformation rate;
the second preset equation is:
$${F}^{′} = \frac{1}{{X}^{′}} [ {u}^{′} - {u}^{0} + {Y}^{′} {F}^{0} - ( \frac{1 - \frac{{k}_{2} Δ t}{2 η}}{1 + \frac{{k}_{2} Δ t}{2 η}} - 1 ) {u}_{2}^{0} + \frac{{F}_{s} Δ t}{{η}_{3}} ]$$
wherein X′ and Y′ are calculated according to following formulas:
$${X}^{′} = \frac{1}{{k}_{1}} + \frac{Δ t}{2 ( 1 + \frac{{k}_{2} Δ t}{2 η} ) η} + \frac{Δ t}{2 {η}_{3}} \\ {Y}^{′} = \frac{1}{{k}_{1}} - \frac{Δ t}{2 ( 1 + \frac{{k}_{2} Δ t}{2 η} ) η} - \frac{Δ t}{2 {η}_{3}}$$
Fₛ is a force on a plastic element; and
S5, judging the unbalanced force of the rock mass region element, and completing a stability evaluation of the tunnel surrounding rock.

2. The method for evaluating the stability of the tunnel surrounding rock considering the creep characteristics of the structural plane according to claim 1, wherein discretizing the tunnel surrounding rock region comprises:
using a quadrilateral element to discretize a rock mass region, using a one-dimensional line element to discretize the structural plane, and nodes of a structural plane element are shared with nodes of a rock mass element.

3. The method for evaluating the stability of the tunnel surrounding rock considering the creep characteristics of the structural plane according to claim 1, wherein initializing the numerical model comprises:
setting parameters and boundary conditions, and initializing a displacement field and a stress field of the numerical model; wherein, the parameters comprise: an elastic modulus of the structural plane, a viscosity coefficient, a plastic limit, an elastic modulus of a rock mass and Poisson's ratio; the boundary conditions comprise a displacement boundary and a mechanical boundary; the displacement field comprises a displacement on the structural plane and a displacement of the rock mass; the stress field comprises a stress on the structural plane and a stress of the rock mass.

4. The method for evaluating the stability of the tunnel surrounding rock considering the creep characteristics of the structural plane according to claim 1, wherein the normal force is:
$${F}_{n} = - {k}_{n} \times {u}_{n}$$
wherein Fₙ is the normal force, kₙ is a normal stiffness, and uₙ is a normal displacement.

5. The method for evaluating the stability of the tunnel surrounding rock considering the creep characteristics of the structural plane according to claim 1, wherein obtaining the nodal force of the rock mass element node comprises: adding the normal force and tangential force of the structural plane node to a corresponding rock mass element node in the numerical model to obtain a new nodal force.

6. The method for evaluating the stability of the tunnel surrounding rock considering the creep characteristics of the structural plane according to claim 1, wherein obtaining the unbalanced force of the rock mass region element comprises:
base on the nodal force, obtaining a nodal velocity of the rock mass region;
based on the nodal velocity, obtaining a strain increment of a rock mass region node;
based on the strain increment, obtaining the stress increment and a total stress of the rock mass region node; and
based on the total stress, obtaining the unbalanced force of the rock mass region element.

7. The method for evaluating the stability of the tunnel surrounding rock considering the creep characteristics of the structural plane according to claim 6, wherein the nodal velocity of the rock mass region is:
$${u}_{i}^{l} ( t + \frac{Δ t}{2} ) = {u}_{i}^{l} ( t - \frac{Δ t}{2} ) + \frac{{F}_{i}^{l} ( t ) + {f}_{i}^{l} ( t )}{{m}^{l} \cdot Δ t}$$
wherein uᵢ^{l} is a velocity of l node in i direction at a time step t, Fᵢ^{l}(t) is an unbalanced force component of the l node in i direction at the time step t, and m^{l} is a concentrated mass of the l node; the strain increment of the rock mass region node is:
$$Δ {ε}_{i j} = \frac{1}{2} ( {u}_{i , j} + {u}_{j , i} ) Δ t$$
wherein Δεᵢⱼ is the strain increment, u_{i,j} is a partial derivative of a displacement uᵢ in xⱼ direction, and u_{j,i} is a partial derivative of displacement uⱼ in xᵢ direction;
the stress increment of the rock mass region node is:
$$Δ {σ}_{ij} = 2 G {ε}_{ij} + \frac{E}{( 1 + μ ) ( 1 - 2 μ )} {ε}_{k k} {δ}_{ij}$$
wherein Δσᵢⱼ is the stress increment, G is a shear elastic modulus, εᵢⱼ is a strain of an element ij, E is the elastic modulus, εₖₖ is an average stress on an element, and δᵢⱼ is a Kronecker symbol; the total stress of rock mass region node is:
$${σ}_{ij} = {\sum }_{t} {Δσ}_{ij}$$
wherein σᵢⱼ is the total stress;
the unbalanced force of the rock mass region element is:
$${F}^{l} = \frac{1}{2} {σ}_{ij} ( {n}^{( 1 )} {S}^{( 1 )} + {n}^{( 2 )} {S}^{( 2 )} )$$
wherein F^{l} is the unbalanced force of the rock mass region element, n⁽¹⁾ is a normal vector of elementary volume side 1, S⁽¹⁾ is an area of the elementary volume side 1, n⁽²⁾ is a normal vector of elementary volume side 2, and S⁽²⁾ is an area of the elementary volume side 2.

8. The method for evaluating the stability of tunnel surrounding rock considering the creep characteristics of structural plane according to claim 1, wherein judging the unbalanced force of the rock mass region element comprises:
judging whether the unbalance force of the rock mass region element is greater than a preset allowable tolerance, if so, reducing a preset creep time, returning to the S3, and re-calculating, otherwise, performing a calculation of a next time step;
judging whether the next time step is greater than the preset creep time, and if not, returning to the S3 for a next round of calculation; if so, ending the calculation to obtain a deformation and a stress of the rock mass and the structural plane;
based on the calculated deformation and stress of the rock mass and the structural plane, obtaining a maximum deformation value of the tunnel surrounding rock region; and
judging whether the maximum deformation value is less than a preset allowable value, if less than the allowable value, a tunnel is stable, otherwise, the tunnel is unstable.
